(19) United States
(12) Patent Application Publication
(10) Pub. No.: US 2014/0011439 A1
(43) Pub. Date: Jan. 9, 2014

(54) HVAC Vent Register Duct Guard

(71) Applicant: Heather Elaine Young, Saint Albans, WV (US)

(72) Inventor: Heather Elaine Young, Saint Albans, WV (US)

(21) Appl. No.: 14/019,636

(22) Filed: Sep. 6, 2013

(51) Int. Cl. F24F 13/20; B23P 19/00

(52) U.S. Cl. CPC F24F 13/20; B23P 19/00
USPC 454/289; 29/428

(57) ABSTRACT

An HVAC vent register duct guard, primarily used with floor register vents, that serves as an addition to a vent register cover to catch items that fall between vent slots/holes into the HVAC duct work. The design consists of a plastic formed mesh basket supported by an upper top lip surround that lets the basket operate independently of the vent register cover. These baskets are specifically sized for standard floor register openings and simply install as a one piece drop in unit underneath the regular vent register cover.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The information set forth herein pertains to the HVAC vent register duct guard which is inserted underneath a decorative vent register cover to protect and catch most items that fall into the vent ducts. The need exists for a protective plastic basket design to enable an individual to retrieve any dropped items since they are very difficult to retrieve once they slide down the duct. With more decorative vent register cover designs on the market, such as the popular scroll work designs, the openings are even larger than the ones on traditional covers leaving a greater open area for anything to fall through. The idea behind the vent register duct guard came from eliminating this possibility and solving this problem with a basket having an upper top lip surround and a mesh basket weave design. It's a companion to a normal vent register cover that allows the cover to still be decorative yet be protected underneath if something should fall through. Another need was the basket installation had to be user friendly so that anyone could use it. Being a one piece drop in unit solved this problem. This design allows for easy cleaning, thus, eliminating replacing baskets, keeping the environment cleaner without waste or replacement parts.

### BRIEF SUMMARY OF THE INVENTION

The HVAC vent register duct guard prevents losing items in the HVAC duct work without obstructing airflow. The basket design will catch most items that fall through the decorative vent register covers and will therefore be easily retrieved by lifting up the vent register cover and pulling the item out of the basket. Since it is installed underneath, it allows the vent register cover to function as normal.

### BRIEF DESCRIPTION OF THE SEVERAL VIEWS OF THE DRAWING

FIG. 1 is a perspective view thereof;

FIG. 2A is a top view thereof;

FIG. 2B is a side view thereof: and

FIG. 3 is an installed view thereof.

### DETAILED DESCRIPTION OF THE INVENTION

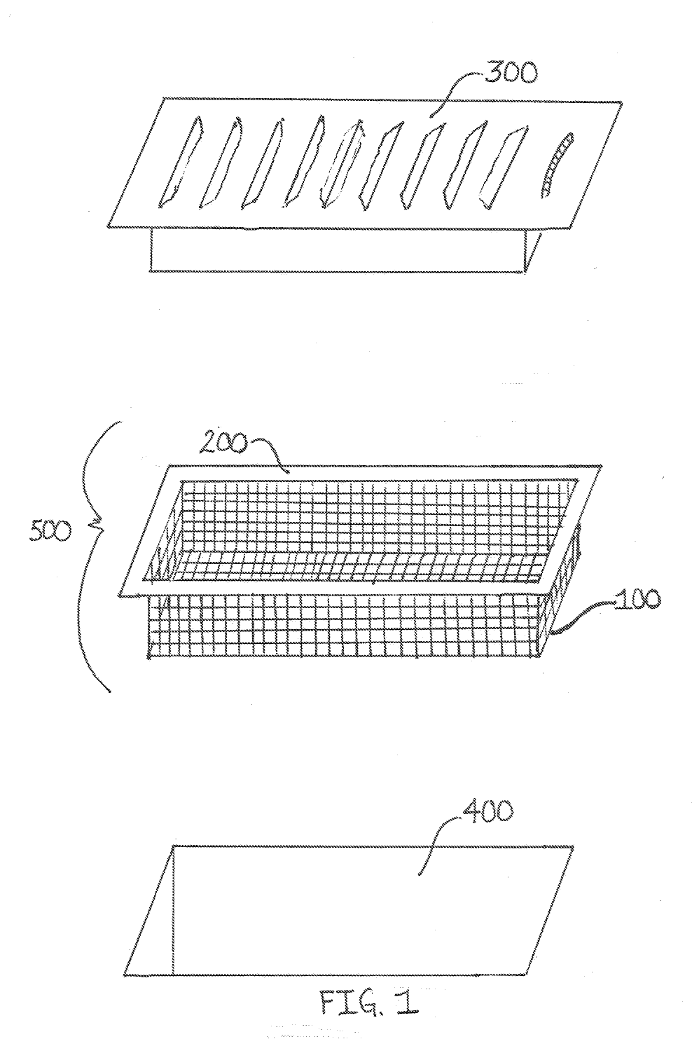

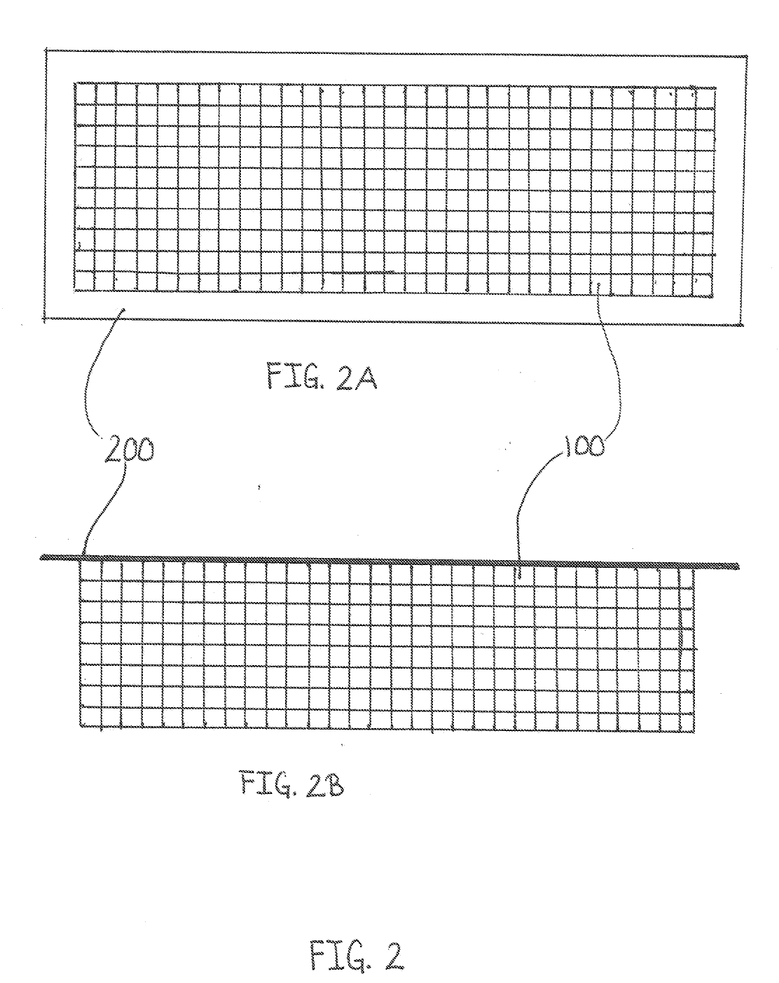

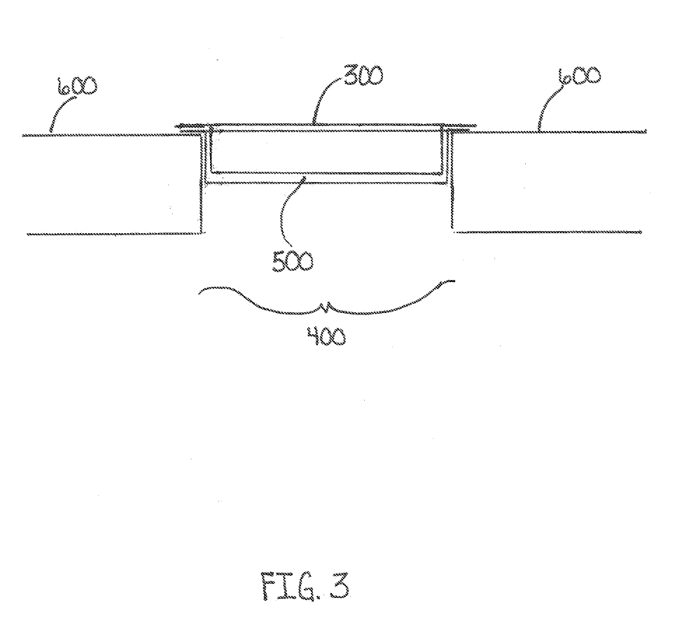

The principles of the vent register basket guard comprise of it being an independent unit that works in conjunction with a regular vent register cover to prevent items from being lost in the HVAC ducts. For it to be independent, a mesh design 100 with an upper top lip surround 200 has been designed so that the vent register cover 300 may sit freely inside the basket in the floor duct opening 400 and still allow the cover to move and function in its regular capacity as illustrated in FIG. 1. This lip is thin enough to remain discreet yet function to stabilize the basket if items fall in. It is a drop in unit and is merely placed underneath the vent register cover 300 by dropping in the vent register basket guard 500 and placing the vent register cover 300 on top as shown in FIG. 1. FIG. 2 comprises the views whereas FIG. 2A represents the top view and FIG. 2B represents the side view with both views showing the mesh design 100 and upper top lip surround 200. The vent register basket 500 as illustrated in FIG. 3 (shown without the mesh for a side point of view illustrated purposes) houses the vent register cover 300 in the HVAC duct opening 400 in the floor 600 as illustrated in FIG. 3.

Unlike other products, the basket design is independent in its installation and it is a solid one piece plastic unit. It will not restrict airflow and provides added security to catch most items in home or commercial use.

It should be understood that these vent baskets are manufactured in each size of register vents on the market and any alterations to the design, size, material, etc. may differ somewhat, however, still stay within the designs laid out in the drawings.

Furthermore, any deviation in the design or use of the aforementioned may be slightly altered as deemed fit by an expert, professional or skilled individual, however, keeping true to the original design of the product. Any modification shall be within the original form and function of the principles stated.

1. The form and function of the mesh basket guard for preventing objects falling through vent register covers into the HVAC ducts as shown and described.

2. The structure of claim 1, whereas it has an upper top lip surround attached to a mesh type basket that allows the basket to sit independently under a normal vent register cover and allow air to continually flow through.

3. The application of claim 2, whereas it is installed by taking the vent register cover off and placing the vent basket in its place, then replacing the vent register cover on top.

4. The technique of claim 3, whereas the mesh is sized so that it will collect the majority of objects yet not impede airflow.
